(19) United States
(12) Patent Application Publication
(10) Pub. No.: US 2025/0253580 A1
(43) Pub. Date: Aug. 7, 2025

(54) Connector

(71) Applicant: TE Connectivity Japan G. K., Kawasaki-shi (JP)

(72) Inventor: Daisuke Uraike, Kawasaki-shi (JP)

(73) Assignee: TE Connectivity Japan G. K., Kawasaki-shi (JP)

(21) Appl. No.: 19/045,646

(22) Filed: Feb. 5, 2025

(30) Foreign Application Priority Data
Feb. 5, 2024 (JP) 2024-015845

(51) Int. Cl. H01R 13/629; H01R 13/502; H01R 13/639

(52) U.S. Cl. CPC H01R 13/62916; H01R 13/502; H01R 13/639

(57) ABSTRACT

A connector includes a housing having a mating opening receiving a mating connector and a sliding member attached to the housing. The sliding member is slidable within the housing along a direction of mating with the mating connector. The sliding member is located in the housing in an initial position and in an unmated state up to completion of mating of the housing and the mating connector.

### CROSS-REFERENCE TO RELATED APPLICATIONS

This application claims the benefit of the filing date under 35 U.S.C. § 119 (a)-(d) of Japanese Patent Application No. 2024-015845, filed on Feb. 5, 2024.

### FIELD OF THE INVENTION

The present disclosure relates to a connector and, more particularly, to a connector including a mechanism for ensuring that the connector is completely mated with a mating connector.

### BACKGROUND OF THE INVENTION

Japanese Patent No. 6213592 discloses a connector including a CPA (Connector Position Assurance) mechanism for ensuring mating with a mating connector. Such a connector enables confirmation of completion of mating with a mating connector by sliding a sliding member attached to a housing from a standby position to a locked position.

The connector disclosed in Japanese Patent No. 6213592 has a sliding member projecting from the housing to an outside of the connector. Around the connector, generally, lie cables extending from the connector and from other connectors positioned around the connector. In the conventional connector, when the cables around the connector are routed, the cables may get caught on the sliding member projecting from the housing, causing damage to the cables and/or the sliding member.

### SUMMARY OF THE INVENTION

A connector includes a housing having a mating opening receiving a mating connector and a sliding member attached to the housing. The sliding member is slidable within the housing along a direction of mating with the mating connector. The sliding member is located in the housing in an initial position and in an unmated state up to completion of mating of the housing and the mating connector.

### BRIEF DESCRIPTION OF THE DRAWINGS

The invention will now be described by way of example with reference to the accompanying figures, of which:

FIG. 1 is an isometric view schematically showing a front side of a connector according to an embodiment of the present disclosure;

FIG. 2 is an isometric view schematically showing a rear side of the connector according to an embodiment of the present disclosure;

FIG. 3 is an exploded isometric view schematically showing the connector according to an embodiment of the present disclosure;

FIG. 4 is an isometric view schematically showing a front side of a housing according to an embodiment of the present disclosure;

FIG. 5 is an isometric view schematically showing a rear side of the housing according to an embodiment of the present disclosure;

FIG. 6 is a top view schematically showing the housing according to an embodiment of the present disclosure;

FIG. 7 is a side view schematically showing the housing according to an embodiment of the present disclosure;

FIG. 8 is an isometric view schematically showing a sliding member according to an embodiment of the present disclosure;

FIG. 9 is a side view schematically showing the sliding member according to an embodiment of the present disclosure;

FIG. 10 is an isometric view schematically showing the connector according to an embodiment of the present disclosure with the sliding member in a first position;

FIG. 11 is a top view schematically showing in the connector according to an embodiment of the present disclosure with the sliding member in the first position;

FIG. 12 is a side view schematically showing in the connector according to an embodiment of the present disclosure with the sliding member in the first position;

FIG. 13 is a rear view schematically showing in the connector according to an embodiment of the present disclosure with the sliding member in the first position;

FIG. 14 is a cross-sectional view schematically showing an A-A cross section in FIG. 13;

FIG. 15 is a cross-sectional view schematically showing a B-B cross section in FIG. 13;

FIG. 16 is a cross-sectional view schematically showing the B-B cross section of the connector according to an embodiment of the present disclosure with the sliding member located between the first position and a second position;

FIG. 17 is an isometric view schematically showing the connector according to an embodiment of the present disclosure with the sliding member in the second position;

FIG. 18 is a top view schematically showing the connector according to an embodiment of the present disclosure with the sliding member in the second position;

FIG. 19 is a side view schematically showing the connector according to an embodiment of the present disclosure with the sliding member in the second position;

FIG. 20 is an A-A cross-sectional view schematically showing the connector according to an embodiment of the present disclosure with the sliding member in the second position;

FIG. 21 a B-B cross-sectional view schematically showing the connector according to an embodiment of the present disclosure with the sliding member in the second position; and

FIG. 22 is an isometric view schematically showing a conventional structure of a connector.

### DETAILED DESCRIPTION

A connector according to an embodiment of the present disclosure will be described in detail below with reference to the drawings. Each element in the drawings is schematically and illustratively shown merely for describing the present disclosure, and may have a different exterior, dimensional ratio, and/or the like from an actual one.

Further, in the following description, terms indicating specific directions and/or positions are used if necessary. The use of these terms, however, is for facilitating understanding the invention with reference to the drawings, and the meanings of these terms shall not limit a technical scope of the present disclosure. In addition, parts denoted by identical reference signs across a plurality of drawings refer to identical or equivalent parts. The size, positional relationship, and/or the like of a member each drawing shows may be exaggeratedly shown for clarifying the description.

In addition, the description of illustrative aspects of the present disclosure is intended to be read in association with the accompanying drawings (the drawings considered to be part of the entire written description). In the description relating to aspects of the present disclosure disclosed herein, any reference to a direction or orientation is for convenience of description only, and is not intended to limit the scope of the present disclosure. Relative terms such as “lower”, “upper”, “horizontal”, “vertical”, “up”, “down”, “top”, and “bottom” and derivative terms thereof such as “horizontally”, “downward”, and “upward” should be construed as referring to a direction as described or as shown in the drawings. Such relative terms are for convenience of description only, and do not require that a device be configured or operated in a particular direction, unless explicitly described otherwise. In addition, terms such as “attached”, “added”, “connected”, “coupled”, and “interconnected”, and similar terms refer to a relationship between structures in which they are fixed or attached to each other directly or indirectly via an intervening object therebetween, and/or their movable or rigid attachment or such a relationship, unless explicitly described otherwise.

Features and benefits of the present disclosure will be illustrated by reference to various aspects. Such aspects will be described in detail enough to enable those skilled in the art to practice the present disclosure. In addition, it should be understood that other aspects may be utilized, and that process, electrical, or mechanical changes may be made without departing from the scope of the present disclosure. Though some configurations may be shown in separate embodiments for convenience, those configurations shown in different embodiments may be partially replaced or combined with each other. Therefore, the present disclosure is explicitly not limited to aspects illustrating a possible non-limiting combination of features (an aspect alone or in combination with other features). In embodiments that will be described later, the description of common matters already described will be omitted, and only differences will be described. In particular, similar actions and effects achieved by similar configurations will not be mentioned one by one for each embodiment.

Features of the present disclosure are related to a structure of a housing associated with a connector position assurance mechanism in a connector. Here, however, in order to grasp a general structure of a connector, a summary of a connector structure will be described below with reference to the drawings.

### <Basic Structure of Connector>

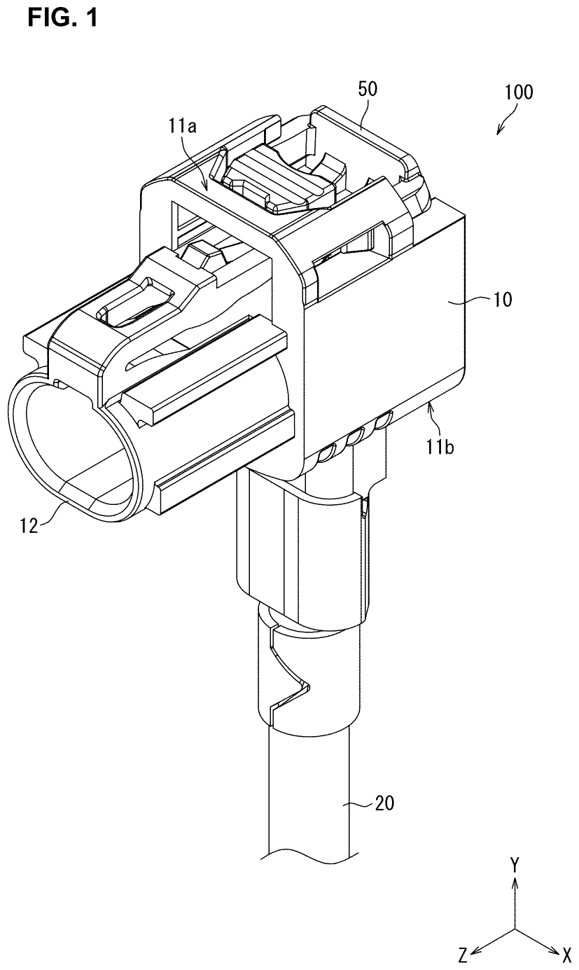

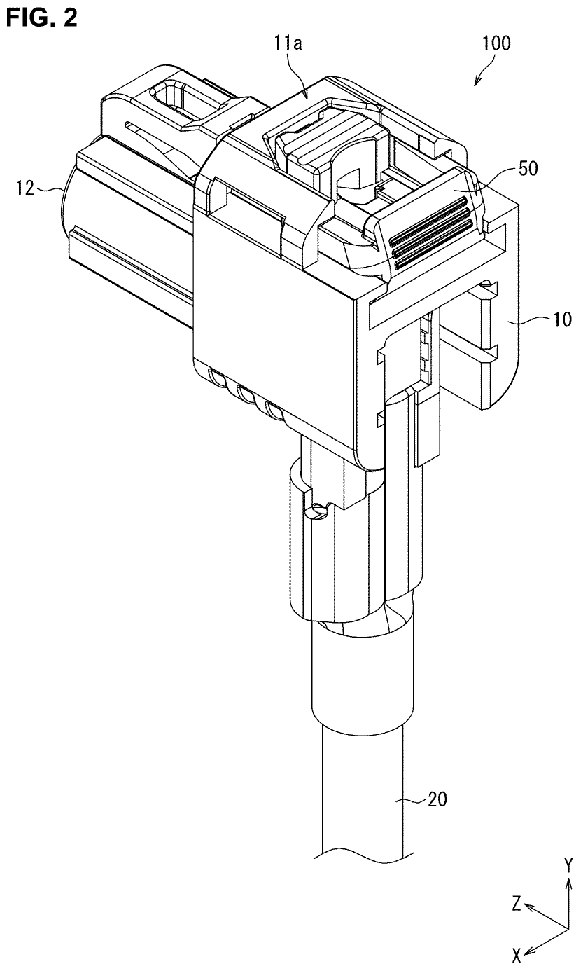

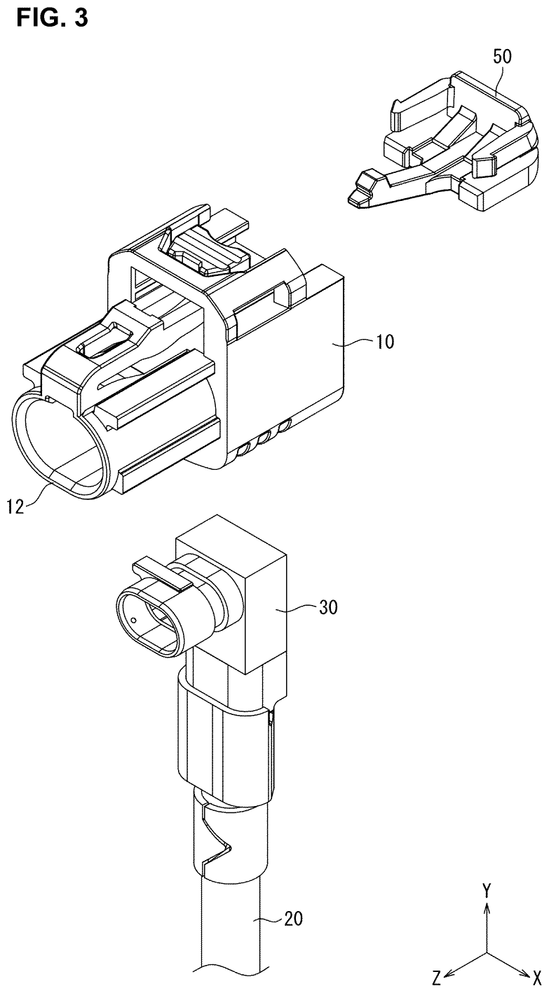

FIG. 1 is an isometric view schematically showing a connector according to an embodiment of the present disclosure. FIG. 2 is an isometric view of a connector 100 shown in FIG. 1 as seen from the opposite side to FIG. 1. FIG. 3 is an exploded view of the connector according to an embodiment of the present disclosure. The connector 100 includes, as main components, a housing 10, a terminal arranged in the housing 10, and a cable 20 connected to the terminal. The connector 100 further includes a sliding member 50 attached to the housing 10.

The housing 10 includes a mating opening 12 combined with a mating connector at the time of mating with the mating connector. The connector and the mating connector are combined through the mating opening 12, thereby bringing the terminal in the housing 10 and a terminal of the mating connector into contact with each other to electrically connect the connectors.

Herein, a side on which the mating opening 12 of the housing 10 is located is referred to as a front side of the connector 100, and the opposite side to the front side as a rear side of the connector 100. In addition, a mating and unmating direction of the connector and the mating connector is referred to as a Z-direction. That is, the front side and the rear side of the connector 100 are positioned facing each other in the Z-direction.

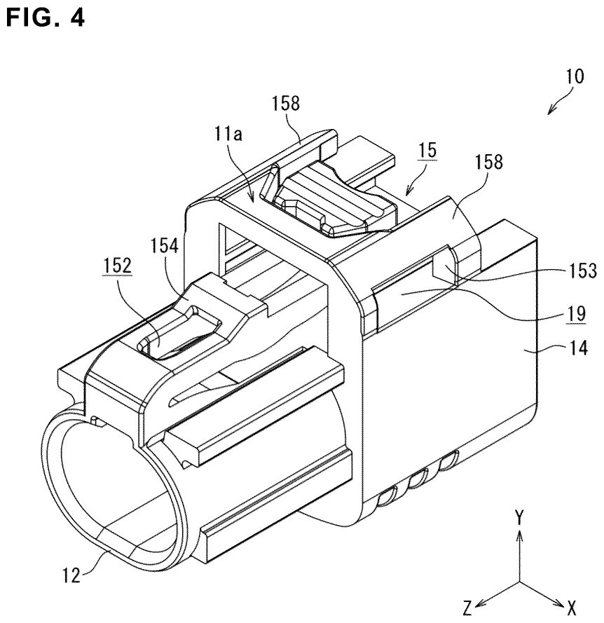

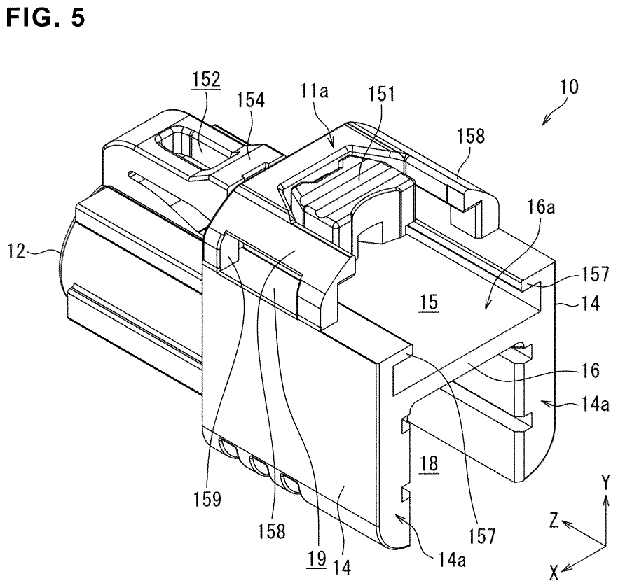

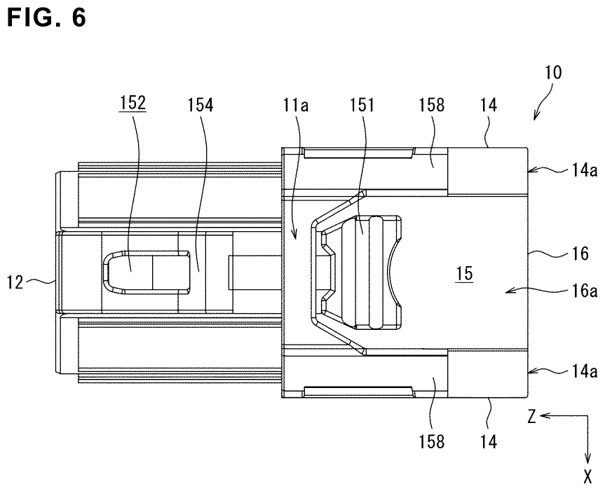

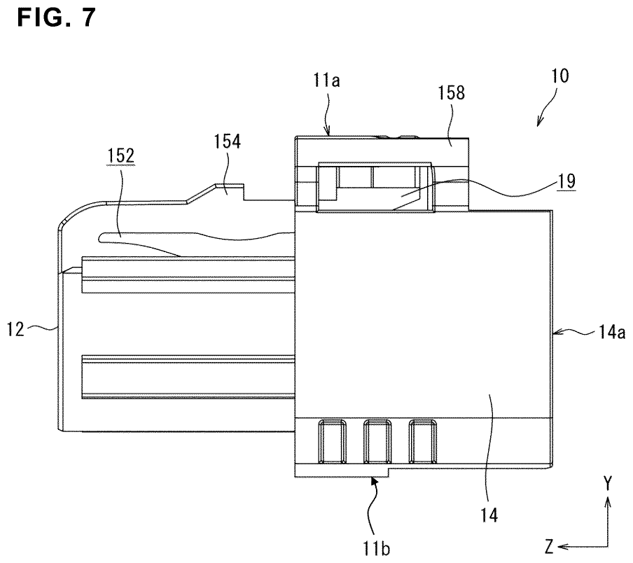

FIGS. 4 and 5 are each isometric views schematically showing the housing 10 according to an embodiment of the present disclosure. In addition, FIGS. 6 and 7 are a top view and a side view, respectively, of the housing 10 according to an embodiment of the present disclosure. The housing 10 includes two sidewalls 14 facing each other in a direction intersecting the Z-direction, and a first main face 11a and a second main face 11b connecting the two side faces. The first main face 11a and the second main face 11b are positioned facing each other (see FIG. 7). For example, as shown in FIGS. 4 to 7, the two sidewalls 14 may face each other in a width direction X of the connector intersecting the Z-direction. The first main face 11a and the second main face 11b may face each other in a Y-direction intersecting the Z-direction and the X-direction mutually.

In an embodiment, the connector 100 may be an L-type connector. More specifically, the connector may be an L-type connector having a cable led out in a direction intersecting the direction of mating with the mating connector (for example, the Y-direction in FIG. 1). For example, as shown in FIG. 1, the connector 100 may include a lead-out opening for the cable 20 in the second main face 11b of the housing 10.

The connector 100 further includes a connector position assurance mechanism (CPA mechanism) for ensuring completion of mating with the mating connector. The connector position assurance mechanism includes the sliding member 50, and a sliding member attachment portion 15 to which the sliding member 50 can be attached. The sliding member attachment portion 15 may be formed in the housing 10 of the connector 100. The connector 100 of the present disclosure is mainly characterized by a structure of the position assurance member attachment portion 15. An illustrative connector position assurance mechanism will be described below.

The sliding member 50, which is configured to be slidingly movable in response to a state of being mated with the mating connector, is attached to the housing 10 of the connector 100 (see FIG. 1). The housing 10 further includes the sliding member attachment portion 15 to which the sliding member 50 can be attached. The sliding member attachment portion 15 may be provided on the first main face 11a side of the housing 10. That is, the sliding member 50 may be attached on the first main face 11a side of the housing 10. The sliding member attachment portion 15 may include a sliding passage 152 extending from the rear side to the front side along the Z-direction and enabling the sliding member 50 to slidingly move (see FIGS. 4 to 7). The sliding member 50 is slidingly movable through the sliding passage 152 along the direction of mating the connector 100 and the mating connector (that is, the Z-direction).

The sliding member attachment portion 15 may be provided with a supporting portion 16 on which the sliding member 50 is placed (see FIG. 5). The supporting portion 16 extends within the housing 10 along the Z-direction that is a sliding direction of the sliding member 50. The sliding member 50 may slidingly move on the supporting portion 16. In addition, the housing 10 is provided with the two sidewalls 14 extending vertically on opposite sides of the supporting portion 16. That is, the sliding member attachment portion 15 may be understood to be a space defined by the supporting portion 16 formed within the housing 10 and the sidewalls 14 of the housing 10 provided on the opposite sides of the supporting portion 16.

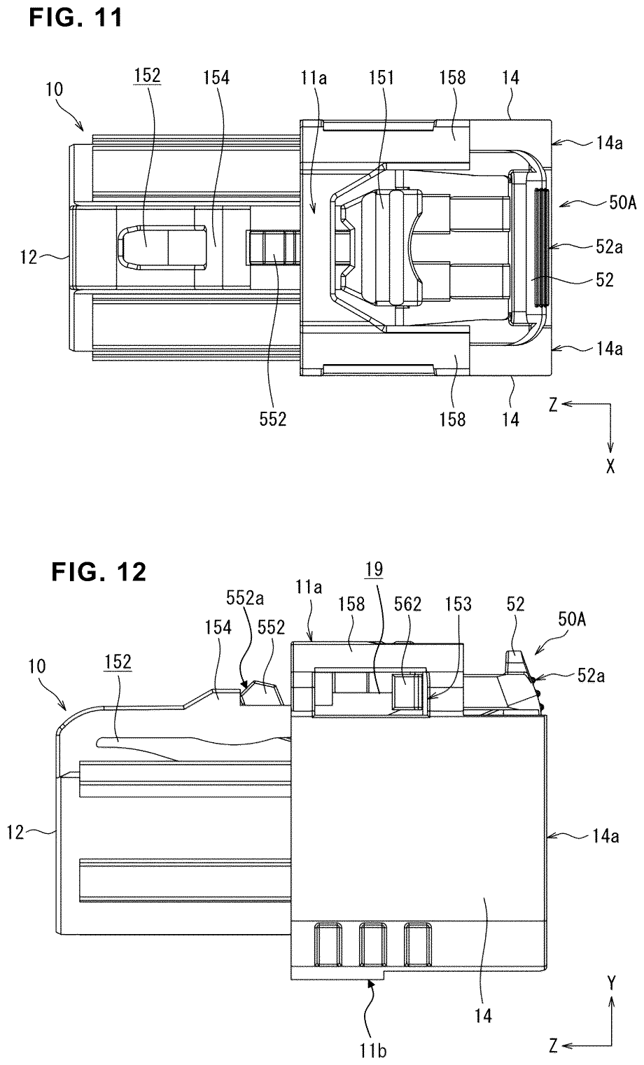

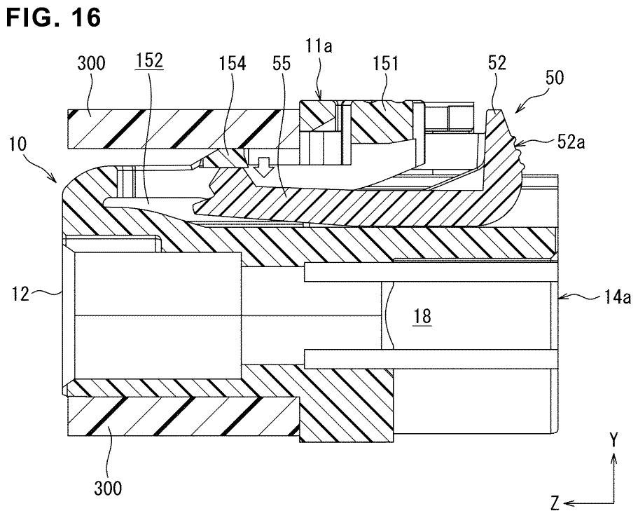

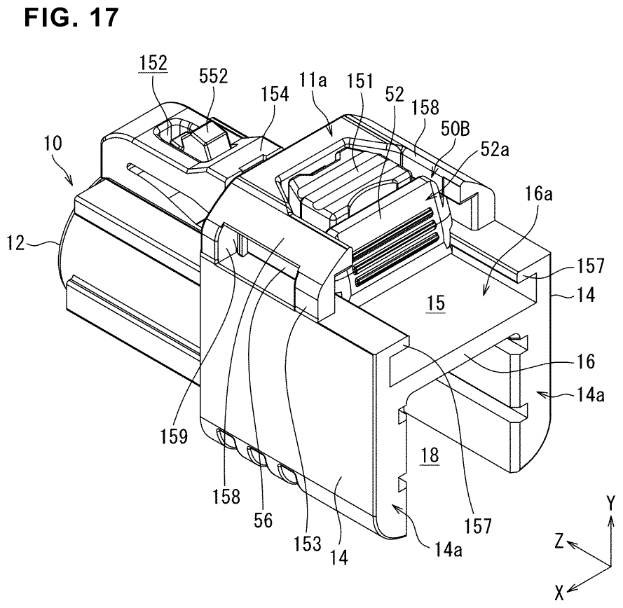

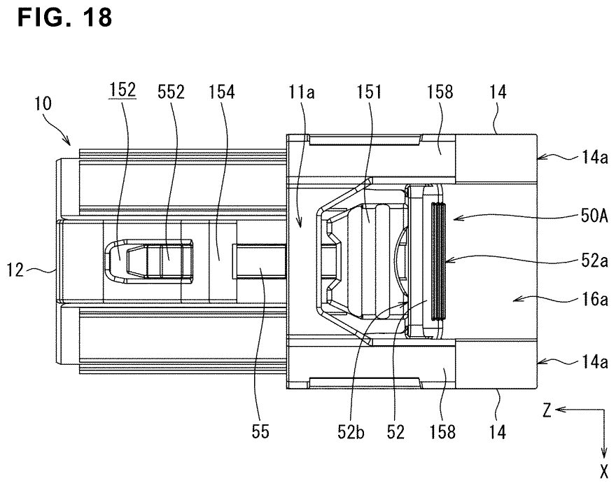

In the sliding member attachment portion 15, the sliding member 50 is slidingly movable between a first position 50A (see FIG. 10) on the rear side of the connector 100 and a second position 50B (see FIG. 17) on the front side of the connector 100. That is, the sliding member 50 can slidingly move along the mating direction Z of the connector 100 between the first position 50A and the second position 50B. FIGS. 10 to 15 are each schematic views showing the housing 10 including the sliding member 50A in the first position. FIG. 16 is a cross-sectional view schematically showing the sliding member 50 located between the first position and the second position. In addition, FIGS. 17 to 21 are each schematic views showing the housing 10 including the sliding member 50 in the second position.

In a state before the connector and the mating connector are combined, the sliding member is arranged in the first position 50A. After the connector is combined with the mating connector, by sliding the sliding member 50 to the second position, successful completion of mating of the connector with the mating connector is ensured. The first position 50A may be referred to as an “initial position” of the sliding member, for example. The second position 50B may also be referred to as a “mating completion position”, a “mating completion assurance position”, or the like, for example. Such a mechanism is referred to as a connector position assurance mechanism, or a CPA mechanism, whereas the sliding member 50 and the sliding member attachment portion 15 may also be referred to as a position assurance member or a CPA member and as a position assurance member attachment portion or a CPA member attachment portion, respectively, or the like.

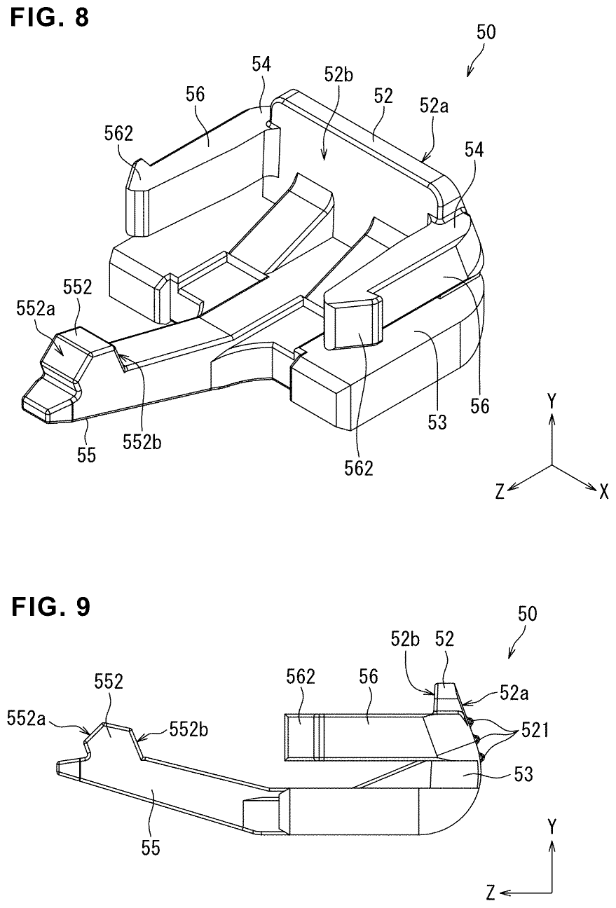

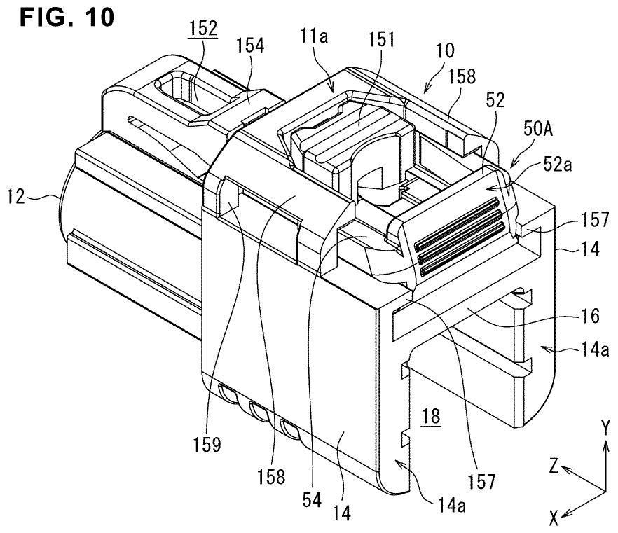

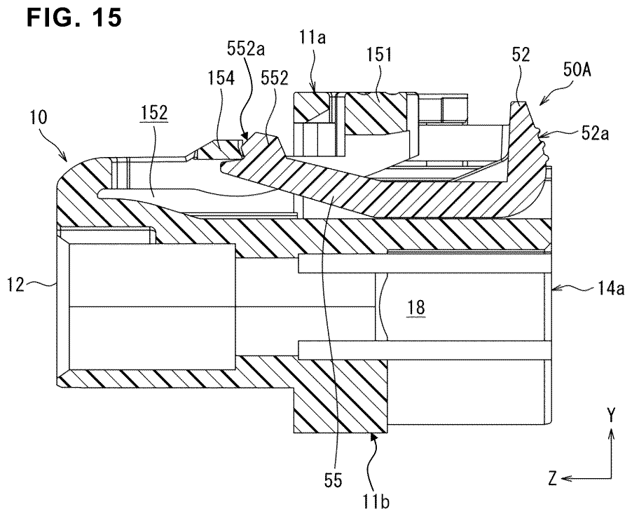

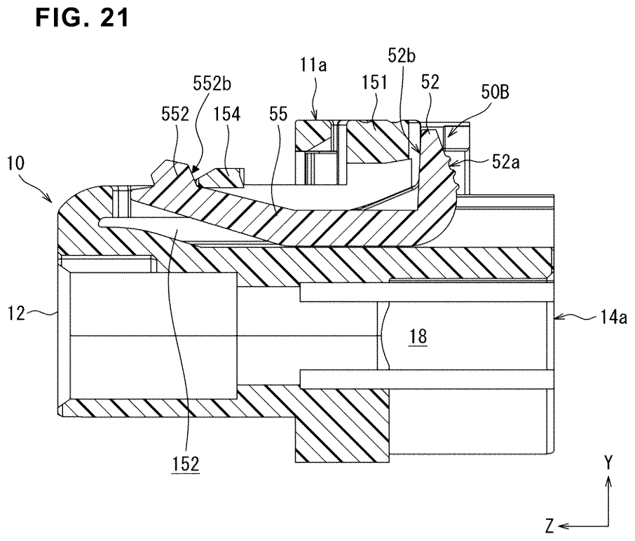

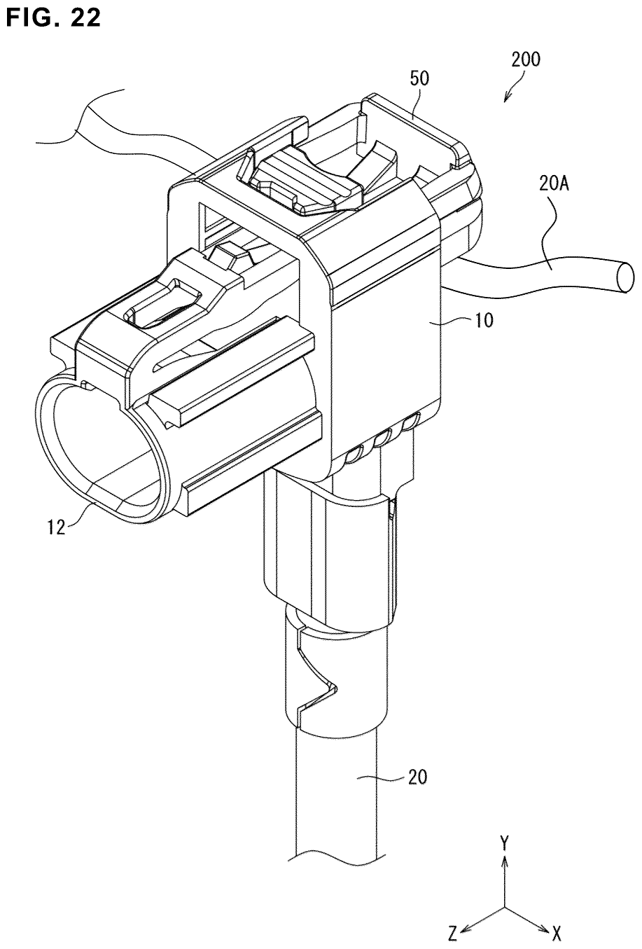

FIGS. 8 and 9 are an isometric view and a side view, respectively, schematically showing the sliding member 50 according to an embodiment of the present disclosure. The sliding member 50 may include an elastic arm 55 extending in a cantilever-like shape toward the front side of the connector 100. The elastic arm 55 includes a distal end 552 projecting toward the first main face 11a side. With the connector and the mating connector in an unmated state, and with the sliding member 50 in the first position 50A, the distal end 552 of the elastic arm 55 faces a retaining portion 154 provided in the housing (see FIG. 15). In the unmated state, a face 552a located on the front side of the distal end 552 of the elastic arm 55 abuts against the retaining portion 154 of the housing 10, thereby preventing the sliding member 50 from slidingly moving from the first position 50A toward the second position 50B (see FIG. 21). That is, in the unmated state, the sliding member 50 is retained in the first position 50A by abutment of the elastic arm 55 against the retaining portion 154 of the housing 10. It should be noted that the “unmated state” herein means a state until before completion of mating of the connector and the mating connector. In short, the state until before completion of mating is equivalent to a state other than the completely mated state. That is, the “unmated state” is a state in which mating of the connector and the mating connector is not completed, encompassing a state before mating, a state at the starting time of mating of the connector and the mating connector, and a state in the middle of a mating operation. That is, the sliding member 50 is retained in the first position 50A, except in the state where mating of the connector and the mating connector is completed.

Once the connector and the mating connector are mated, the mating connector and the elastic arm 55 of the sliding member 50 abut against each other, causing the elastic arm 55 to deflect toward the inside of the housing 10. This releases the abutment in the sliding direction Z of the elastic arm 55 against the retaining portion 154 of the housing 10, allowing the sliding member 50 to slidingly move toward the second position 50B (see FIG. 21). When the sliding member 50 in this state is pushed in toward the front side along the sliding direction Z, the elastic arm 55 can be deflected toward the inside of the housing 10 while the inclined face 552a formed at the distal end of the elastic arm 55 is abutting against the retaining portion 154 (see FIG. 16). By pushing in the sliding member 50 further, the sliding member 50 can be moved to the second position 50B through the sliding passage 152 (see FIG. 21).

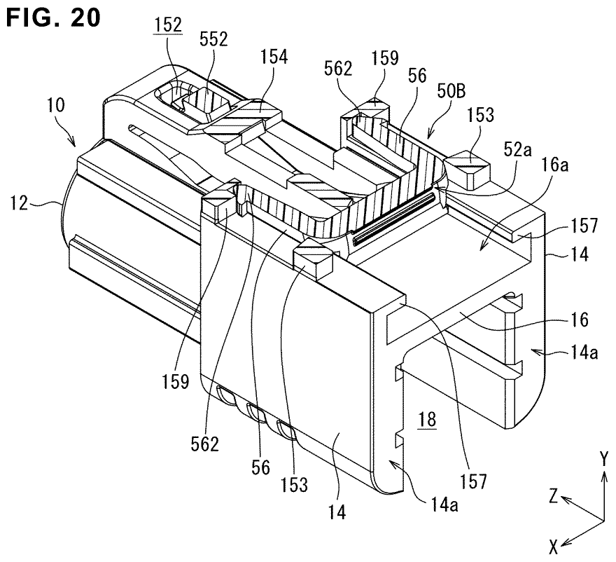

As shown in FIG. 20, the sliding member 50 which has moved to the second position 50B may be restricted from moving further toward the front side beyond the second position 50B by abutment of a hook portion 562 at a distal end of a side arm 56 against a catching face 159 of the housing. In addition, the sliding member 50 may be retained in the second position 50B by abutment of a face 552b (see FIG. 9) on the rear side at the distal end 552 of the elastic arm 55 against the retaining portion 154. The face 552b may be an inclined face inclined gradually from the second position 50B toward the first direction 50A (see FIG. 12) (that is, toward the rear side of the connector). Such a feature allows a user to slidingly move the sliding member 50 to the first position 50A when the user pulls a base portion 52 toward the rear side.

That is, successful mating of the connector and the mating connector enables slidingly moving the sliding member 50 to the second position 50B. In other words, in the unmated state where the connector and the mating connector are not successfully mated, the sliding member 50 is prevented from moving from the first position 50A to the second position 50B, whereas, in the completely mated state where the connector and the mating connector are mated, the sliding member 50 can be moved from the first position 50A toward the second position 50B. That is, in a state other than the completely mated state, the sliding member 50 is not allowed to slidingly move toward the second position 50B. Such a structure enables a user to determine whether or not the connector and the mating connector have been successfully completely mated by sliding the sliding member 50 to the second position 50B.

### <Features of the Connector of the Present Disclosure>

The connector 100 of the present disclosure is characterized by an attachment structure for the sliding member 50. Features of the connector 100 of the present disclosure will be described in detail below.

The connector 100 of the present disclosure is characterized in that the sliding member 50 is slidingly movable in the housing 10. In the connector 100 of the present disclosure, the sliding member 50 with the housing 10 and the mating connector in an unmated state is located in the housing 10. That is, the connector 100 of the present disclosure is configured such that the initial position of the sliding member 50 is inside the housing. More specifically, in the connector 100 of the present disclosure, the sliding member 50 is configured to be slidingly movable between the first portion 50A in the housing 10 and the second position 50B located in the housing 10 similarly and nearer to the front side than the first position 50A. That is, the sliding member 50 may be attached inside the housing 10. For example, in order to prevent the sliding member 50 from projecting out of the housing 10, the connector may be provided with a stopper mechanism for preventing the sliding member 50 from moving toward the rear side beyond the first position 50A.

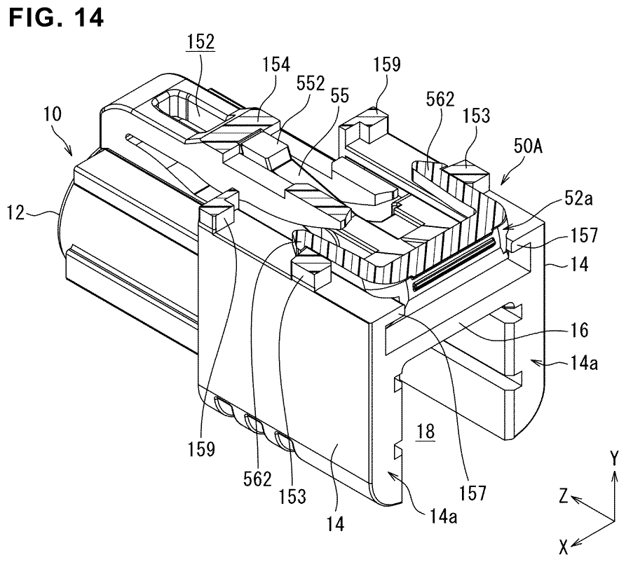

For example, as shown in FIG. 8, the sliding member 50 may include the side arm 56 arranged on the sidewall 14 side of the housing 10, and the hook portion 562 may be formed at the distal end of the side arm 56. On the other hand, as shown in FIG. 4, the sliding member attachment portion 15 of the housing 10 may be formed with an engaging face 153 that can engage with the hook portion 562 at the distal end of the side arm 56. As shown in FIG. 14, the sliding member 50A in the first position may be prevented from moving toward the rear side beyond the first position 50A by engagement of the engaging face 153 of the housing 10 and the hook portion 562 of the sliding member. Such engagement also contributes to preventing the sliding member 50 from projecting out of the housing 10.

Here, “in the housing”, “within the housing”, and “inside the housing” herein mean that a target object lies in a position coinciding with an outer contour of the housing 10 or inside the outer contour. That is, the target object may not necessarily be surrounded by the housing 10, and, for example, part of the target object may form the outer contour of the housing 10 and be exposed outside the housing 10. This means that a plane formed by part of the housing 10 and part of the target object is generally flat.

In such a configuration, the sliding member 50 does not include a portion projecting to the outside of the housing 10. The sliding member 50 does not project to the outside of the housing 10 even in the first position 50A that is the rearmost arrangement. That is, the sliding member 50, both in the first position 50A and in the second position 50B, may be located inside the housing 10 without projecting from the outer contour of the housing 10 on the rear side of the connector 100. In other words, the sliding member attachment portion 15 of the housing 10 may be configured such that the sliding member 50 is positioned inside the housing 10.

According to the configuration described above, since the sliding member 50 is located inside the housing 10, the sliding member 50 is arranged within the housing 10 without projecting therefrom. Therefore, the likelihood that the cable 20A (see FIG. 22) routed around the connector 10 gets caught on the sliding member 50 can be reduced. This makes it possible to inhibit damage to the cable 20A and/or the connector due to catching of the cable 20A at the time of cable routing. Further, since catching of the cable 20A on the sliding member 50 is inhibited, working efficiency in cable routing can be improved. Therefore, according to the present disclosure, a connector enabling more suitable cable routing is provided.

As shown in FIGS. 10 to 21, the sliding member 50 may include a base portion 52 located on the rear side of the connector 10. The base portion 52 may be positioned at an end portion on the rear side of the sliding member 50. Therefore, the base portion 52 may also be referred to as a rear-side end portion of the sliding member 50. A user may slidingly move the sliding member 50 by operating the base portion 52.

The base portion 52 includes an outer face 52a arranged on the rear side of the housing 10. The outer face 52a can also be understood to be an end face of the sliding member 50 located on the rear side. A user can slidingly move the sliding member 50 from the first position toward the second position by pushing in the outer face 52a. As shown in FIG. 12, the outer face 52a may be an inclined face inclined gradually in a front direction of the connector toward the first main face side 11a of the housing 10 with respect to the extending direction Y of an end face 14a of the sidewall 14. For example, the inclined face may be a flat face, or may include a curved face in a side view shown in FIG. 12. Such a structure allows the sliding member 50 to slidingly move from the first position toward the second position smoothly even if a force is applied obliquely to the sliding direction X when a user pushes in the sliding member 50. That is, a direction in which a user pushes in the sliding member 50 is not limited to a direction along the sliding direction X, and therefore operability in moving the sliding member 50 can be improved.

In addition, as shown in FIG. 9, the outer face 52a of the base portion 52 may be formed with one or more raised portions 521 extending along an extending direction of the outer face 52a. For example, the outer face 52a may have two or more raised portions 521 extending linearly along the width direction X of the connector. Such a raised portion 521 can function as a slip stopper when a user slidingly moves the sliding member 50, and can contribute to improvement of operability in moving the sliding member 50.

In the connector 100 of the present disclosure, the base portion 52 of the sliding member 50 may be located inside the housing 10. That is, both when the sliding member 50 is in the first position 50A and when the sliding member 50 is in the second position 50B, the rear-side end portion of the sliding member 50 may be located inside the housing 10. For example, the entire sliding member 50, including the base portion 52, may be arranged inside the housing 10 by positioning the sidewalls 14 of the housing 10 on opposite sides of the base portion 52. In other words, the sidewalls 14 may extend along the sliding direction Z at least to the outer face 52a of the base portion 52 of the sliding member 50 lying in the first position in order to position the sliding member 50 inside the housing 10. That is, the base portion 52 of the sliding member 50A in the first position may be positioned between the sidewalls 14 of the housing 10.

More specifically, with the sliding member 50 in the first position 50A, the base portion 52 of the sliding member 50 may be arranged to be substantially flush with the end faces 14a on the rear side of the sidewalls 14 of the housing 10. That is, with the sliding member in the first position, the rear side of the housing 10 may be made generally flat by the base portion 52 of the sliding member 50 and the end faces 14a of the sidewalls 14 of the housing 10. Herein, “substantially flush” and “generally flat” means that, in a side view, the base portion 52 of the sliding member 50 is positioned on the same plane as the end faces 14a without projecting from the rear side of the housing 10, allowing small unevenness or the like. According to such a structure, since a projection of the sliding member 50 on which a cable can get caught is not present with the sliding member 50 in the first position, more suitable cable routing becomes possible.

Alternatively, with the sliding member 50 in the first position 50A, the base portion 52 of the sliding member 50 may be positioned further inside than the end faces 14a on the rear side of the sidewalls 14 of the housing 10. That is, in a side view, the base portion 52 of the sliding member 50 may be offset to the inside of the housing 10 with respect to the Z-direction from the end faces 14a of the sidewalls 14 of the housing 10. In other words, the sidewalls 14 of the housing 10 may extend outward along the Z-direction beyond the base portion 52 of the sliding member 50 arranged in the first position. According to such a structure, since the sliding member 50 is suitably protected from outside by the sidewalls 14 of the housing 10, damage to the sliding member 50 due to catching in cable routing can be inhibited. In addition, since the sliding member 50 slidingly moves between the first position and the second position within the housing 10, accidental trapping of a cable routed around the connector 100 during the sliding movement can be inhibited.

In the configuration described above, the sliding member 50, both in the first position 50A and in the second position 50B, may be configured such that lateral portions of the sliding member 50 face the sidewalls 14 of the housing 10. For example, the sliding member 50, both in the first position 50A and in the second position 50B, may be configured such that the lateral portions of the sliding member 50 face the sidewalls 14 of the housing 10 along the sliding direction Z. In an embodiment, the lateral portions of the sliding member 50 may face the sidewalls 14 of the housing over the entire region. This enables the sliding member 50 arranged in the sliding member attachment portion 15 to be suitably retained within the housing 10 by the sidewalls 14 of the housing 10, not only in the second position 50B after sliding to the inside of the connector 100, but also in the first position 50A located on the rear side of the connector 100. This makes it possible to inhibit rattling of the sliding member 50 in the housing 10, and to perform a slide movement of the sliding member 50 more smoothly.

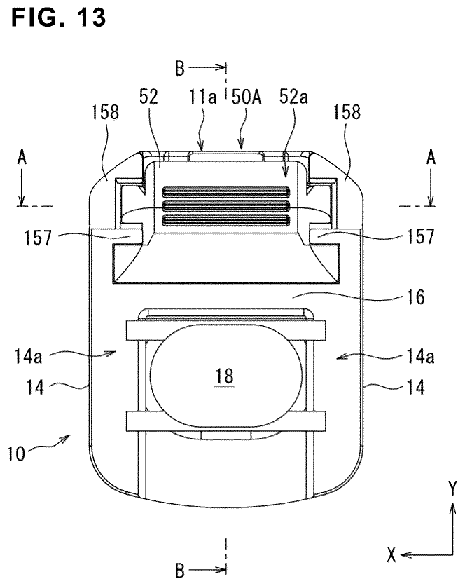

The sidewalls 14 of the housing 10 may further include a guiding portion 157 extending along the Z-direction that is a moving direction of the sliding member 50 (see FIG. 5). The guiding portion 157 may extend to the end face 14a of the sidewall 14 on an inner side of the sidewall 14. A side face of the sliding member 50 facing the sidewall 14 may be configured to be engageable in a tongue-and-groove manner with the guiding portion 17. More specifically, as shown in FIGS. 8 and 9, the base portion 52 of the sliding member 50, in the first position, may be engageable in a tongue-and-groove manner with the guiding portion on its side face facing the sidewall. The sliding member 50 may include a guided portion 53 on its side face engageable in a tongue-and-groove manner with the guiding portion 157. The sliding member 50 may be slidingly movable in the Z-direction by sliding along the guiding portion 17 with the guiding portion 157 and the guided portion 53 combined with each other (see FIGS. 10 and 13). That is, the guiding portion 157 can contribute to guiding of a sliding movement of the sliding member 50.

The guided portion 53 of the sliding member 50 may be so formed as to extend to the base portion 52. For example, the guided portion 53 may be so formed as to extend to the end face 52a on the rear side of the sliding member 50. As described above, in the connector 100 of the present disclosure, the sliding member 50 is positioned inside the connector 100, and is slidable between the first position 50A and the second position 50B in the housing 100. Therefore, the sliding member 50 is slidingly movable between the first position 50A and the second position 50B with the guided portion 53 engaged in a tongue-and-groove manner with the guiding portions 17 of the housing 10 over its entire region.

Specifically, the sliding member 50 may include a groove portion 53 extending along the Z-direction in which the sliding member 50 slides, on a side facing the sidewall 14 of the housing 10. In addition, the guiding portion 157 provided on the sidewall 14 of the housing 10 may be a rib extending along the Z-direction and configured to be combinable with the groove portion 53. A rib 157 may project from the sidewall 14 of the housing 10 toward the inside of the housing 10. The sliding member 50 may be combined with the sliding member attachment portion 15 by inserting the rib 157 of the housing 10 into the groove portion 53, and be guided to slidingly move along the Z-direction by the rib 17.

FIG. 22 is an isometric view schematically showing a conventional connector 200. As shown, in the conventional connector 200, with the sliding member 50 on the rearmost side (that is, in a position corresponding to the first position), a portion on the rear side of the sliding member 50 projects from the housing 10. Therefore, with the sliding member 50 in the first position, part of the groove portion 53 on the rear side projects out of the housing 10, and is therefore not combined with the rib of the housing 10. In such a structure, when the sliding member 50 is in the first position, only a front side of the sliding member 50 is retained by the housing 10, so that the sliding member 50 may rattle.

On the other hand, in such a connector of the present disclosure as shown in FIG. 10, even with the sliding member 50 in the first position, the groove portion 53 on the rear side is combined with the rib 157 without protruding from the housing 10. More specifically, in the sliding member 50A arranged in the first position, the groove portion 53 extending to the outer face 52a of the base portion 52 is combined with the rib 157 of the housing 10. Therefore, according to the connector 100 of the present disclosure, even when the sliding member 50 is located on the rearmost side (that is, located in the first position), the groove portion 53 of the sliding member 50 and the rib 157 of the housing 10 are combined with each other over a wide range, and thereby rattling of the sliding member 50 can be more suitably inhibited.

It should be noted that, though the sliding member 50 has been described in the drawings and in the above as including the groove portion 53, and the housing 10 as including the rib 157, they are not necessarily limited to this configuration. For example, the number of groove portions 53 and ribs 157 is not particularly limited, and one, two, three, or more groove portions 53 and ribs 157 may be formed. For example, the sliding member 50 may include a rib projecting toward the sidewall 14 of the housing 10, and the sidewall 14 of the housing 10 may include a groove portion combined with the rib.

In an embodiment, the sliding member 50 may include a cutout portion 54 at two corner portions on the first main face 11a side (see FIGS. 8 and 10). In addition, the sidewall 14 of the housing 10 includes a hook portion 158 combined with the cutout portion 54 and extending in a band-like shape in the Z-direction on the first main face side where the sliding member attachment portion 15 is located. The hook portion 158 may be formed by an end edge of the sidewall 14 of the first main face 11a side becoming relatively thick, such that the sidewall 14 bends along an extending direction of the first main face 11a. With the sliding member 50 attached to the sliding member attachment portion 15, the hook portion 158 is located further outside the connector 100 than the cutout portion 54. In such a structure, the sidewall 14 of the housing 10 is so combined as to cover the corner portion of the sliding member 50. The cutout portion 54 of the sliding member 50 and the hook portion 158 of the housing 10 are combined with each other, and thereby the sliding member 50 can be prevented from fall off from the first main face 11a side of the sliding member attachment portion 15. That is, by meshing of the cutout portion 54 and the hook portion 158 of the housing 10, the sliding member 50 is retained in the sliding member attachment portion 15. Further, since the hook portion 158 extends along the Z-direction, it can also function as a guide for a sliding movement of the sliding member 50 along the Z-direction.

For example, the hook portion 158 may extend along the sliding direction Z to the end face 14a on the rear side of the housing 10. In this manner, even with the sliding member 50 arranged in the first position that is the rearmost arrangement, the cutout portion 54 and the hook portion 158 may be combined with each other along the sliding direction Z. This makes the cutout portion 54 and the hook portion 158 engageable over a wider range, so that the attitude of the sliding member 50 in the first position is more suitably retained.

As described above, according to the connector 100 of the present disclosure, since the sliding member 50 has a structure that does not project out from the rear side of the housing 10, catching of a cable routed around the connector 100 can be inhibited. Further, the connector 100 of the present disclosure may have a structure where the sliding member 50 does not project out from the first main face 11a side of the housing 10, either (see FIG. 12). For example, the sliding member 50, including the base portion 52 positioned at the rear-side end portion of the sliding member 50, may be located further inside the housing 10 than a virtual plane extending along the first main face 11a of the housing 10. That is, the sliding member 50 may have a structure that does not project not only from the rear side of the housing 10 but also from the first main face 11a side. By such a structure, even when cables of other connectors are routed on the first main face 11a of the connector 10, damage to the cable and/or the sliding member due to the cable getting caught on the sliding member 50 of the connector of the present disclosure can be inhibited.

In the connector 100 of the present disclosure, a face 16a (see FIG. 5) of the supporting portion 16 extending to connect the two sidewalls 14 of the housing 10 can function as a sliding face for the sliding member 50 moving in the housing 10. The sliding face 16a is a face facing the sliding member 50 and extending in the X-direction and the Y-direction. The supporting portion 16 including the sliding face 16a may extend to the rear side of the housing 10. More specifically, the supporting portion 16 may extend along the Z-direction between the two sidewalls 14 of the housing 10, and form an end face flush with the end faces 14a on the rear side of the sidewalls 14. The supporting portion 16 may extend to the base portion 52 of the sliding member 50A arranged in the first position. In other words, the sliding member 50 may be arranged in the first position such that the base portion 52 is positioned on the supporting portion 16. This enables the sliding member 50A arranged in the first position to be suitably retained by the supporting portion 16 over a wide range including the base portion 52. Therefore, the supporting portion 16 suitably retains the sliding member 50 in the sliding member attachment portion 15, reduces rattling of the sliding member 50, and enables the sliding member 50 to slidingly move more smoothly along the sliding face 16a of the supporting portion 16.

Further, since the supporting portion 16 connecting the sidewalls 14 extends to the rear face of the housing 10, the supporting portion 16 can also suitably function as a beam for supporting the housing structure. Therefore, the strength of the housing 10 is improved, so that deformation of the housing 10 due to pressure applied from outside or the like can be inhibited. This enables suitable retention of the shape of the sliding passage for the sliding member 50 in the sliding member attachment portion 15. That is, by the presence of the supporting portion 16 extending to the rear face of the housing so as to be flush with the end faces 14a of the sidewalls 14, the sliding passage through which the sliding member 50 can suitably slidingly move can be secured.

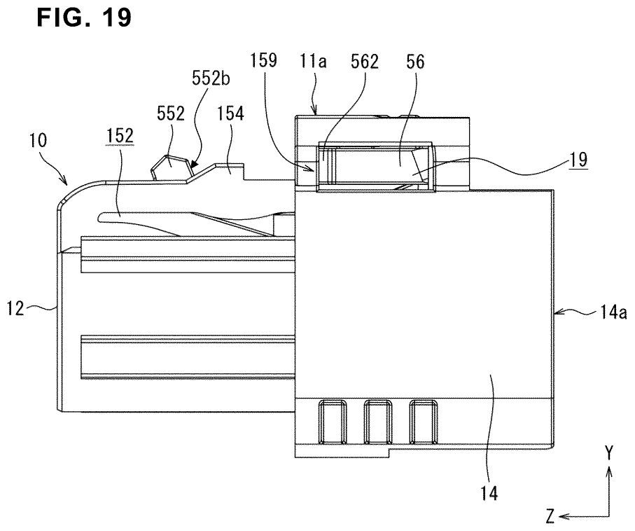

As shown in FIG. 7, the sidewall 14 of the housing 10 may be provided with a window portion 19 passing therethrough to the inside of the housing 10. The window portion 19 functions as a detection window for confirming whether or not the sliding member 50 is arranged in the second position in the sliding member attachment portion 15. The window portion 19 may be configured to allow the position of the sliding member 50 located inside the housing 10 to be confirmed in a side view. For example, as shown in FIGS. 12 and 19, the window portion 19 may be configured to allow the position of the distal end 562 of the side arm of the sliding member 50 to be confirmed. In such a configuration, when the sliding member 50 is located in the first position, the distal end 562 of the side arm may be located on the rear-side face 153 side (see FIG. 12). On the other hand, when the sliding member 50 is located in the second position, the distal end 562 of the side arm may be positioned on the front-side face 159 side (see FIG. 19). By confirming that the distal end 562 of the side arm is located on the face 159 side of the window portion, a user can determine whether or not the connector and the mating connector have successfully been mated.

Alternatively, the window portion 19 may be configured to enable detection of the position of the sliding member 50 according to whether or not the sliding member 50 is in a position that is visually observable through the window portion 19. For example, in a side view, when the sliding member 50 is in the second position, the sliding member 50 may be located nearer to the front side than the window portion 19. In other words, the window portion 19 may be positioned nearer to the rear side than the sliding member 50 arranged in the second position. By such a structure, when the sliding member 50 is in the first position, the sliding member 50 can be confirmed through the window portion 19, and on the other hand, when the sliding member 50 is in the second position, the sliding member 50 cannot be confirmed through the window portion 19. Therefore, according to whether or not the sliding member 50 can be confirmed through the window portion 19, the position of the sliding member 50 can also be determined in a side view. This enables a user to determine whether or not the sliding member 50 has been in the second position, and mating with the mating connector has been completed, by confirming whether or not the sliding member 50 can be visually observed through the window portion 19.

A connector including a connector position assurance mechanism of the present disclosure can be suitably utilized in various technical fields in which an electrical connection is required.

Though embodiments of the present invention have been described above, the present invention is not limited to these embodiments, and various modifications based on knowledge of those skilled in the art, such as combining the configurations described above, can be made without departing from the spirit of the claims.

1. A connector, comprising:
a housing having a mating opening receiving a mating connector; and
a sliding member attached to the housing, the sliding member is slidable within the housing along a direction of mating with the mating connector, the sliding member is located in the housing in an initial position and in an unmated state up to completion of mating of the housing and the mating connector.

2. The connector according to claim 1, wherein the sliding member, with the housing and the mating connector completely mated, is slidingly movable from the initial position to a mating completion position closer to the mating opening than the initial position.

3. The connector according to claim 1, wherein the sliding member is accommodated inside the housing.

4. The connector according to claim 1, wherein the sliding member includes a base portion located on a side opposite to the mating opening in a sliding direction of the sliding member, the base portion is located inside the housing.

5. The connector according to claim 1, wherein the housing includes a sidewall extending along a sliding direction of the sliding member, the sliding member in the initial position is located further inside the housing than the sidewall.

6. The connector according to claim 4, wherein the housing includes a sidewall extending along the sliding direction of the sliding member and the base portion includes a corner portion located outside the housing, the sidewall covers the corner portion.

7. The connector according to claim 4, wherein the housing includes a sidewall extending along the sliding direction of the sliding member, the sidewall includes an end face located on a side opposite to the mating opening in the sliding direction of the sliding member, the end face is flush with an outer face of the base portion of the sliding member in the initial position.

8. The connector according to claim 4, wherein the housing includes a sidewall extending along the sliding direction of the sliding member, the sidewall includes an end face located on a side opposite to the mating opening in the sliding direction of the sliding member, the base portion is located further inside the housing than the end face in the sliding direction.

9. The connector according to claim 4, wherein the housing includes a sidewall extending along the sliding direction of the sliding member, the sidewall includes a guiding portion extending in the sliding direction, the base portion of the sliding member in the initial position is engageable in a tongue-and-groove manner with the guiding portion on a side face facing the sidewall.

10. The connector according to claim 9, wherein the guiding portion includes a tongue shape projecting into the housing on the sidewall, the sliding member includes a groove portion extending along the sliding direction on the side face facing the sidewall, the sliding member is slidable along the guiding portion engaged with the groove portion.

11. The connector according to claim 1, wherein the housing includes a pair of sidewalls facing each other across the sliding member and extending along a sliding direction of the sliding member.

12. The connector according to claim 11, wherein the housing includes a supporting portion connecting the pair of sidewalls and extending to a pair of end faces of the pair of sidewalls located on a side opposite to the mating opening along the sliding direction, the sliding member is slidable along the sliding direction on the supporting portion.

13. The connector according to claim 12, wherein the sliding member includes a base portion located on a side opposite to the mating opening in the sliding direction of the sliding member, the base portion in the initial position is arranged on the supporting portion.

14. The connector according to claim 1, wherein the housing includes a sidewall extending in a sliding direction of the sliding member, the sidewall includes a window portion allowing detection of the sliding member in a mating completion position nearer to the mating opening than the initial position.

15. The connector according to claim 3, wherein the sliding member is entirely contained within the housing in the initial position.

16. The connector according to claim 4, wherein the sliding member has a side arm extending from the base portion along the sliding direction, the side arm has a hook portion at a distal end.

17. The connector according to claim 16, wherein the housing has an engaging face that engages the hook portion in the initial position and prevents movement of the sliding member out of the housing in a direction opposite to the sliding direction.

18. The connector according to claim 4, wherein the sliding member has an elastic arm extending from the base portion along the sliding direction, the elastic arm has a distal end with a first inclined face on a first side and a second inclined face on a second side opposite the first side.

19. The connector according to claim 18, wherein, in the initial position, the elastic arm abuts against the housing and prevents the sliding member from moving along the sliding direction.

20. The connector according to claim 19, wherein in a mated state of the housing and the mating connector, the first inclined face abuts against the housing, the elastic arm is deflectable toward an inside of the housing, and the sliding member is movable along the sliding direction.
